(19) United States
(12) Patent Application Publication
(10) Pub. No.: US 2026/0222940 A1
(43) Pub. Date: Jul. 30, 2026

(54) L1-RSRP MEASUREMENT FOR LTM

(71) Applicant: INTEL CORPORATION, Santa Clara, CA (US)

(72) Inventors: Hua Li, Beijing 11 (CN); Meng Zhang, Beijing (CN); Andrey Chervyakov, Maynooth (IE); Rui Huang, Beijing (CN); In-Seok Hwang, Santa Clara, CA (US)

(21) Appl. No.: 19/148,826

(22) PCT Filed: Feb. 16, 2024
(86) PCT No.: PCT/US2024/016194

§ 371 Date: Jul. 17, 2025

Related U.S. Application Data
(60) Provisional application No. 63/485,762, filed on Feb. 17, 2023.

(51) Int. Cl. H04W 36/04; H04B 17/318; H04W 36/00; H04W 76/20

(52) U.S. Cl. CPC H04W 36/04; H04B 17/328; H04W 36/0058; H04W 76/20

(57) ABSTRACT

An apparatus and system are described for performing a L1-Reference Signal Received Power (L1-RSRP) measurement and reporting the results for L1/L2 triggered mobility (LTM). After transmission of a L3 measurement report to a 5th generation NodeB (gNB), a user equipment (UE) receives a Radio Resource Control (RRC) reconfiguration message from the gNB. The RRC reconfiguration message contains a configuration for a Layer 1/Layer 2 (L1/L2) triggered mobility (LTM) target cell. The UE receives a Medium Access Control (MAC) Control Element (MAC CE) containing a cell switch command to switch to the LTM target cell. The UE performs a L1-RSRP measurement on the LTM target cell after switching to the LTM target cell using a rough beam.

### PRIORITY CLAIM

This application claims the benefit of priority to U.S. Provisional Patent Application Ser. No. 63/485,762, filed Feb. 17, 2023, which is incorporated herein by reference in its entirety.

### BACKGROUND

Mobile communication has evolved significantly from early voice systems to highly sophisticated integrated communication platform. Next-generation (NG) wireless communication systems, including 5th generation (5G) and sixth generation (6G) or new radio (NR) systems, are to provide access to information and sharing of data by various users (e.g., user equipment (UEs)) and applications. NR is to be a unified network/system that is to meet vastly different and sometimes conflicting performance dimensions and services driven by different services and applications. As such the complexity of such communication systems has increased. As expected, a number of issues abound with the advent of any new system, including complexities related to mobility procedures.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some aspects.

FIG. 3 illustrates a Layer 1/Layer 2 (L1/L2) triggered mobility (LTM) framework in accordance with some aspects.

FIG. 4 illustrates performance of L1-Reference Signal Received Power (L1-RSRP) before a cell switch command in accordance with some aspects.

FIG. 5 illustrates performance of L1-RSRP after a cell switch command in accordance with some aspects.

FIG. 6 illustrates a method of reporting L1-RSRP in accordance with some aspects.

FIG. 7 illustrates a LTM decision making process in accordance with some aspects.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

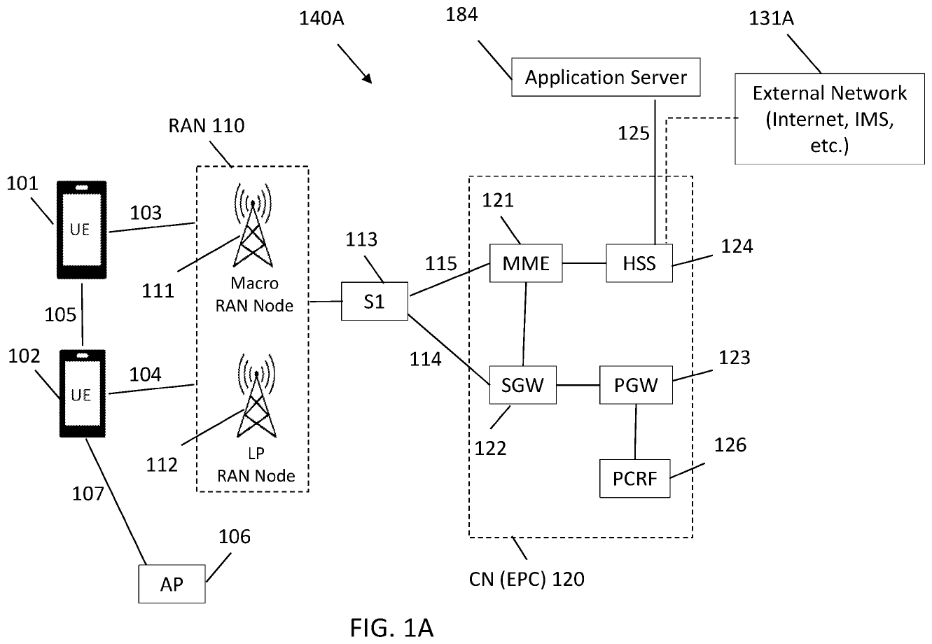

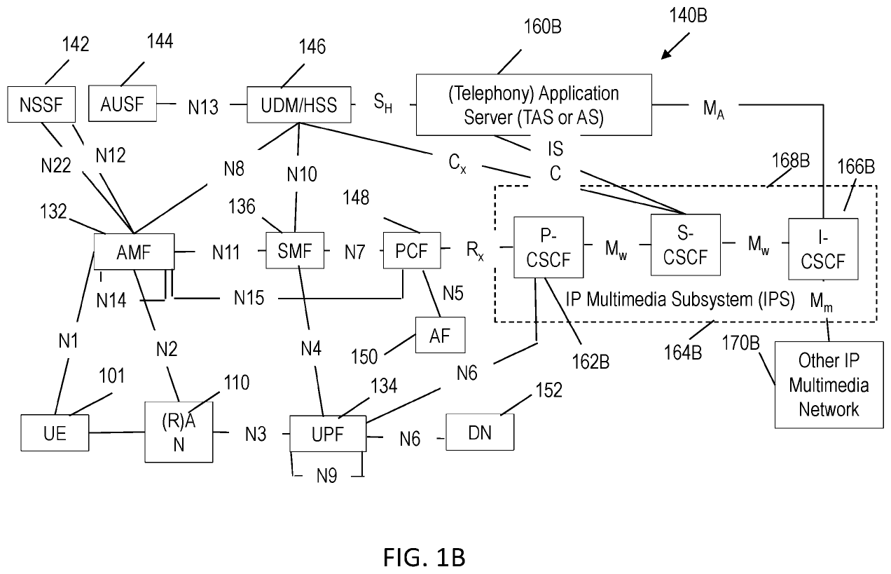

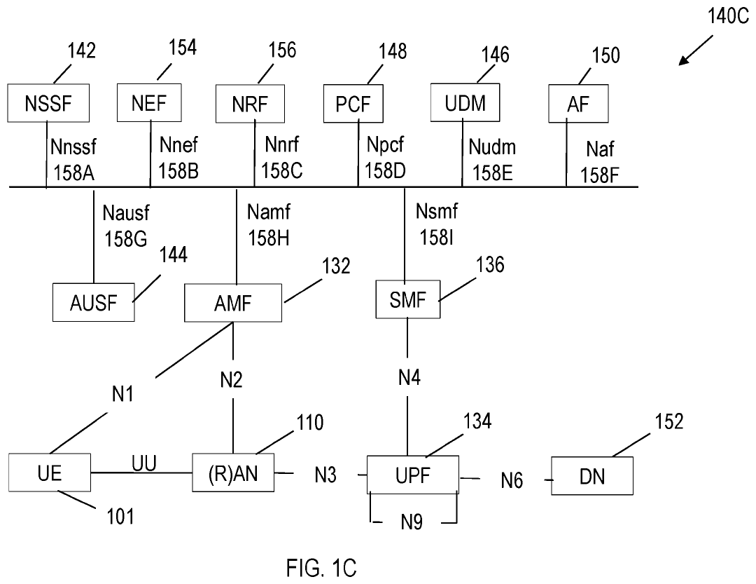

FIG. 1A illustrates an architecture of a network in accordance with some aspects. The network 140A includes 3GPP Long Term Evolution (LTE), 4^{th} generation (4G) and 5^{th} generation (5G) (or next generation (NG)) network functions that may be extended to 6G functions. Accordingly, although 5G will be referred to, it is to be understood that this is to extend as able to 6G structures, systems, and functions. A network function may be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 may be collectively referred to herein as UE 101, and UE 101 may be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHZ, 3.4-3.6 GHZ, 3.6-3.8 GHz, and other frequencies and Spectrum Access System (SAS) in 3.55-3.7 GHZ and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and may be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a UMTS protocol, a 3GPP LTE protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) may be referred to as base stations (BSs), NodeBs, evolved NodeBs (eNBs), 5^{th} Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 may be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and may be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 may be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A may be an IoT network or a 5G or 6G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a 5G core network (5GC) 120. The NG-RAN 110 can include a plurality of nodes, such as gNBs and NG-eNBs. The CN 120 (e.g., a 5G core network/5GC) can include an access and mobility function (AMF) and/or a user plane function (UPF). The AMF and the UPF may be communicatively coupled to the gNBs and the NG-eNBs via NG interfaces. More specifically, in some aspects, the gNBs and the NG-eNBs may be connected to the AMF by NG-C interfaces, and to the UPF by NG-U interfaces. The gNBs and the NG-eNBs may be coupled to each other via Xn interfaces.

In some aspects, the NG system architecture can use reference points between various nodes. In some aspects, each of the gNBs and the NG-eNBs may be implemented as a base station, a mobile edge server, a small cell, a home eNB, and so forth. In some aspects, a gNB may be a primary node (MN) and NG-eNB may be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 may be in communication with RAN 110 as well as one or more other 5GC network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 may be used to manage access control and mobility and can also include network slice selection functionality. The AMF 132 may provide UE-based authentication, authorization, mobility management, etc., and may be independent of the access technologies. The SMF 136 may be configured to set up and manage various sessions according to network policy.

The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 may be deployed in one or more configurations according to the desired service type and may be connected with a data network. The PCF 148 may be configured to provide a policy framework using network slicing, mobility management, and roaming (similar to PCRF in a 4G communication system). The UDM may be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1B), or interrogating CSCF (I-CSCF) 166B. The P-CSCF 162B may be configured to be the first contact point for the UE 102 within the IM subsystem (IMS) 168B. The S-CSCF 164B may be configured to handle the session states in the network, and the E-CSCF may be configured to handle certain aspects of emergency sessions such as routing an emergency request to the correct emergency center or PSAP. The I-CSCF 166B may be configured to function as the contact point within an operator's network for all IMS connections destined to a subscriber of that network operator, or a roaming subscriber currently located within that network operator's service area. In some aspects, the I-CSCF 166B may be connected to another IP multimedia network 170B, e.g., an IMS operated by a different network operator.

In some aspects, the UDM/HSS 146 may be coupled to an application server 184, which can include a telephony application server (TAS) or another application server (AS) 160B. The AS 160B may be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures may be service-based and interaction between network functions may be represented by corresponding point-to-point reference points Ni or as service-based interfaces.

In some aspects, as illustrated in FIG. 1C, service-based representations may be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein may be used for supporting high reliability in distributed communication systems with dynamic topologies, including sidelink NR V2X communication systems.

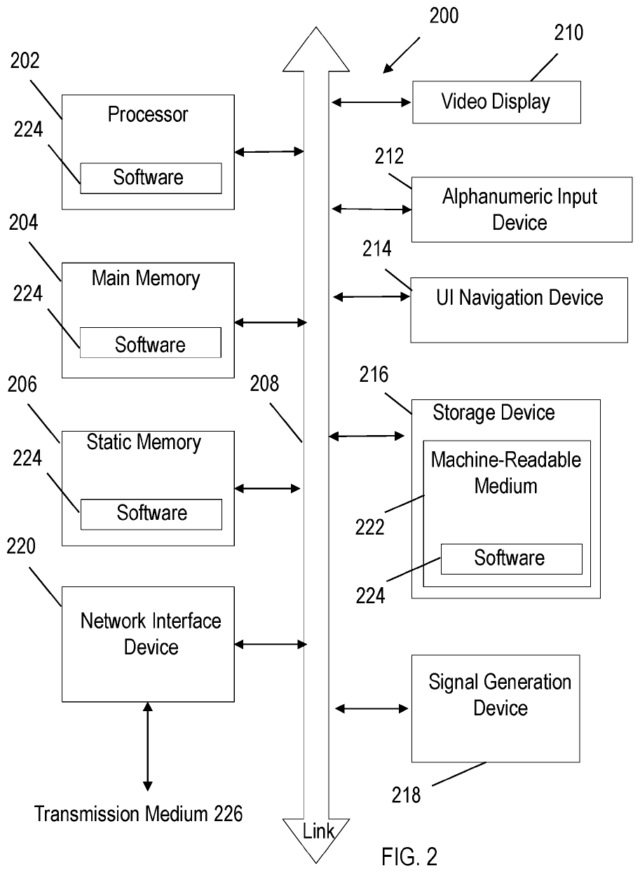

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or another sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The non-transitory machine readable medium 222 is a tangible medium. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as IEEE 802.11 family of standards known as Wi-Fi, IEEE 802.16 family of standards known as WiMax, IEEE 802.15.4 family of standards, an LTE family of standards, a UMTS family of standards, peer-to-peer (P2P) networks, a 5G standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a GSM radio communication technology, a GPRS radio communication technology, an Enhanced Data Rates for GSM Evolution (EDGE) radio communication technology, and/or a Third Generation Partnership Project (3GPP) radio communication technology, for example UMTS, Freedom of Multimedia Access (FOMA), 3GPP LTE, 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), UMTS (3G), Wideband Code Division Multiple Access (UMTS) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), UMTS-Time-Division Duplex (UMTS-TDD), TD-CDMA, Time Division-Synchronous Code Division Multiple Access, 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), E-UTRA, LTE Advanced (4G), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), PTT, Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as 3GPP Generic Access Network, or GAN standard), Zigbee, Bluetooth(r), Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (12V) communication technologies, 3GPP cellular V2X, Dedicated Short Range Communications (DSRC) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety related applications in the frequency range 5,875 GHz to 5,905 GHZ), ITS-G5B (i.e., Operation in European ITS frequency bands dedicated to ITS non-safety applications in the frequency range 5,855 GHz to 5,875 GHZ), ITS-G5C (i.e., Operation of ITS applications in the frequency range 5,470 GHz to 5,725 GHz)), DSRC in Japan in the 700 MHz band (including 715 MHz to 725 MHz), IEEE 802.11bd based systems, etc.

Aspects described herein may be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System/CBRS=Citizen Broadband Radio System in 3.55-3.7 GHZ and further frequencies). Applicable spectrum bands include International Mobile Telecommunications spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHz, 1710-2025 MHz, 2110-2200 MHz, 2300-2400 MHz, 2.4-2.4835 GHz (note: it is an ISM band with global availability and it is used by Wi-Fi technology family (11b/g/n/ax) and also by Bluetooth), 2500-2690 MHz, 698-790 MHz, 610-790 MHz, 3400-3600 MHz, 3400-3800 MHz, 3800-4200 MHz, 3.55-3.7 GHz (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively. Next generation Wi-Fi system is expected to include the 6 GHz spectrum as operating band, but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHz, 3800-4200 MHz, 3.5 GHz bands, 700 MHz bands, bands within the 24.25-86 GHz range, etc.), spectrum made available under FCC's “Spectrum Frontier” 5G initiative (including 27.5-28.35 GHZ, 29.1-29.25 GHZ, 31-31.3 GHZ, 37-38.6 GHZ, 38.6-40 GHz, 42-42.5 GHZ, 57-64 GHz, 71-76 GHz, 81-86 GHz and 92-94 GHz, etc.), the ITS (Intelligent Transport Systems) band of 5.9 GHz (typically 5.85-5.925 GHZ) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHZ) and WiGig Band 4 (63.72-65.88 GHz), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHZ, and future bands including 94-300 GHz and above. Furthermore, the scheme may be used on a secondary basis on bands such as the TV White Space bands (typically below 790 MHz) where in particular the 400 MHz and 700 MHz bands are promising candidates. Besides cellular applications, specific applications for vertical markets may be addressed such as Program Making and Special Events (PMSE), medical, health, surgery, automotive, low-latency, drones, etc. applications.

As above, LTM was introduced in Rel. 18. For LTM, cell switch may be triggered by a lower layer command (L1 is the Physical Layer, L3 is the RRC Layer). This allows the cell to be able to be changed more quickly compared with legacy cellular systems, in which high layer control is used for cell handover. For LTM, beam level measurement (L1-RSRP measurement) is performed and reported. The report result may be used by the network to trigger a L1/L2 based cell switch while keeping configuration of the upper layers and/or minimizing changes of configuration of the lower layers. The UE procedure to perform L1-RSRP measurement and report is described herein.

L1 measurements are useful for procedures which react with minimal delay, e.g., beam management procedures in which the UE rapidly switches between beams. The beam-level measurements are filtered at L1 to help remove the impact of noise and to improve measurement accuracy. L3 measurements are useful for radio resource management decisions that use a long-term view of channel conditions, e.g., handover procedures are triggered after L3 filtering to reduce the risk of ping-ponging between cells. L3 measurements are filtered to remove the impact of fast fading and to help reduce short term variations in results and can be either at the beam level or cell level (which may be reported within an RRC message). For example, L3 measurements may be an average of two or more L1 measurements. Beam level measurements are generated directly from L1 measurements by applying L3 filtering; cell level measurements are derived from the L1 measurements.

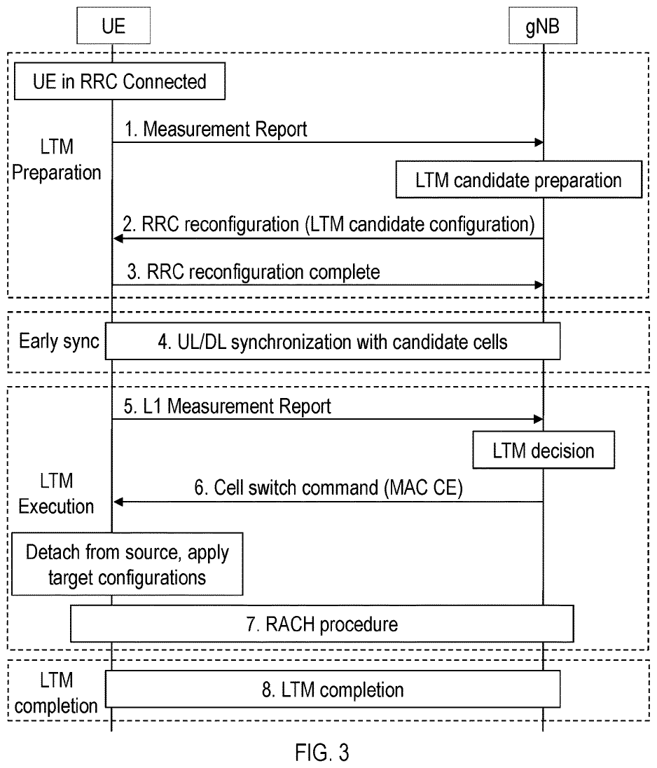

FIG. 3 illustrates a LTM framework in accordance with some aspects. The procedure shown in FIG. 3 includes 4 operations: LTM preparation, early synchronization, LTM execution, LTM completion. In the first operation (LTM preparation), a L3 measurement report is provided from the UE to the gNB. The gNB may determine LTM candidate cells and prepare the LTM candidate cells for transfer of the UE. Based on the L3 measurement report, the gNB may then send a configuration for the LTM candidate cells to the UE in a Radio Resource Control (RRC) reconfiguration message. The UE may respond to the RRC reconfiguration message with a RRC reconfiguration complete message to the gNB to indicate that the reconfiguration preparations have been completed.

In the second operation (early synchronization), the UE synchronizes with candidate cells determined by the gNB and indicated in the RRC configuration message. The UE may perform downlink (DL) synchronization and timing advance (TA) acquisition with the LTM candidate cells before receiving the LTM cell switch command.

In the third operation (LTM decision), the UE performs L1 measurements on the configured LTM candidate cells and sends a L1 measurement report to the gNB, which makes a LTM decision based thereon. If the gNB determines that the UE is to move to another (target) cell, a cell switch command is triggered and sent to the UE in a Medium Access Control (MAC) Control Element (MAC CE). The UE detaches from the source cell and applies the configuration associated with the target cell before engaging in the Random Access Channel (RACH) procedure with the target cell.

In the fourth operation (LTM completion), the UE indicates successful completion of the LTM cell switch towards the target cell. In LTM, the UE may perform a partial or full MAC reset, may re-establish radio link control (RLC), and may perform data recovery with packet data convergence protocol (PDCP) during the cell switch.

From the signalling procedure of RAN2, the L3 measurement results are reported by the UE for LTM preparation. The L3 measurement report is transmitted before L1 measurement is configured. That is, the UE provides the L3 measurement results to the gNB for LTM candidate preparation. L1 measurement are not configured for unknown cells where L3 measurement is not performed.

Before discussing how the L1-RSRP measurement is performed for LTM, the motivation for the L1 measurement and report for LTM (i.e., whether the L1 measurement is for beam management and/or mobility). The method of performing the L1-RSRP measurement may depend on, e.g., whether within the Synchronization Signal/Physical Broadcast Channel (SS/PBCH) Block Measurement Timing Configuration (SMTC), Receive (Rx) beam assumption, timing offset, bandwidth part (BWP), etc.

The L1 measurement and report motivation has an impact on the entire L1-RSRP requirement. For example, if the L1 measurement and report is for mobility, similar to the legacy procedure, a rough beam can be assumed and the L1 measurement and report can be performed inside the SMTC. If the L1 measurement and report is for beam management, a fine beam can be assumed and the L1 measurement and report is performed outside SMTC as the legacy Rel-17 inter-cell beam management (BM) procedure.

In LTM however, the L1-RSRP report is used for both beam management and mobility purposes. The UE may perform beam level measurement and the beam index may be directly applied after the cell switch from source cell to target cell. Since the motivation of the L1 measurement is a combination of mobility and beam management, there are two options for the baseline of L1 measurement framework: L3 measurement framework for mobility or L1 measurement for beam management. Accordingly, any analysis should approach the L1 measurement from these two aspects.

### Beam Management Perspective

One difference of beam assumption for mobility and beam management is the granularity: i.e., whether the beam is a rough beam or a fine beam (as defined by 3GPP). If the intermediate result of the L3 measurement is able to be re-used for the L1 report, the beam index is derived based on a rough beam. After the cell switch, the rough beam is used for reception at the UE side. However, the UE is able to continue to perform fine beam acquisition later.

With an intermediate L3 result, the UE may still be able to report the beam index. After the cell switch, data may still be able to be received by the rough beam initially and further updated by the L1-RSRP measurement.

The measurement delay may be analyzed for fine beam acquisition before and after the cell switch. The intra-frequency measurement case is discussed first, in which two options exist for acquiring a fine beam. In the first option, the fine beam is identified before the cell switch; in the second option, the fine beam is identified after the cell switch. The rough beam is basis for both options. Thus, only the extra delay for fine beam acquisition is compared.

For option 1, if fine beam acquisition for a candidate cell is performed before the cell switch command, the legacy Rel-17 L1 measurement for inter-cell beam management (ICBM) can be used as baseline. For simplicity, no SMTC and measurement gap (MG) is considered. Since sharing is applied between cells due to overlapped Synchronization Signal Block (SSB) for intra-frequency scenarios, the delay is scaled by number of mobility candidate cells plus the serving cell. The delay for acquiring a fine beam is given by: T_{SSB}*8*(N+1), where N is the number of mobility candidate cells (1 is the serving cell).

For option 2, the rough beam-based beam index is reported before the cell switch based on the intermediate L3 result; fine beam acquisition is performed after the cell switch. Since the candidate cell becomes the serving cell, sharing may be avoided. The delay can be further reduced if the Channel State Information Reference Signal (CSI-RS) is configured for a L1-RSRP measurement after the cell switch since the CSI-RS may have shorter periodicity compared with the SSB. While the L1-RSRP may be performed before cell switch, only SSB-based measurement is supported currently. The delay for acquiring a fine beam is thus given as: T_{SSB}*8*1 or T_{CSI-RS}*8*1.

For the intra-frequency case, if the L1-RSRP measurement is performed before the cell switch, at least N times the measurement delay is used compared with the L1-RSRP measurement being performed after the cell switch. In fact, the delay of LTM will be extended due to the L1 measurement latency.

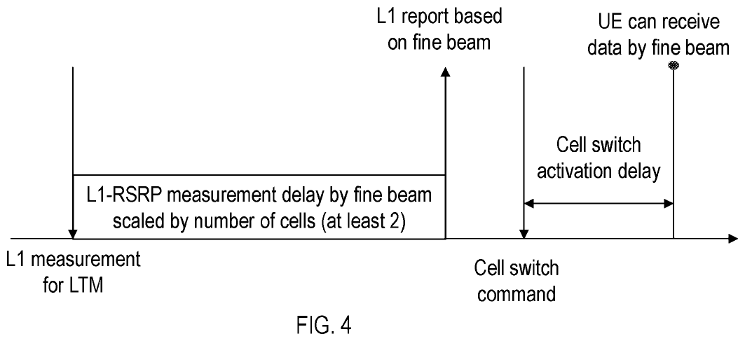

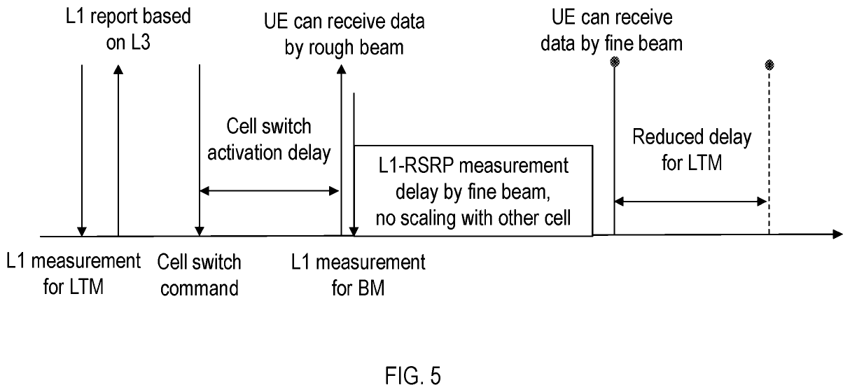

FIG. 4 illustrates performance of L1-RSRP before a cell switch command in accordance with some aspects. FIG. 5 illustrates performance of L1-RSRP after a cell switch command in accordance with some aspects. The LTM delay from the L1 measurement shown in FIG. 4 is configured to the receive or transmit time the UE. Normally, the end point of the cell switch is the time that the UE is able to receive or transmit data, which does not limit whether a rough beam or fine beam is used. For a fair comparison, the end point is considered to be the time that fine beam-based data transmission is available for both cases. As shown in FIG. 4, for option 1, due to the longer measurement delay of L1, the network configures the cell switch later. While for FIG. 5, the network is able to trigger a cell switch faster, and thus the fine beam is acquired in a shorter time than in FIG. 4. This is to say that the total delay of LTM is reduced if fine beam acquisition is performed after the cell switch.

### Mobility Perspective

On the other hand, a more stable result is desired from a mobility perspective. RAN1 also identifies issues when the L1 measurement is used for mobility, that is the occurrence of frequent cell switching or ping-ponging between cells. In Rel-17, a 1-shot or 3 shots-based L1-RSRP measurement is performed for beam management. If the mobility decision is based on the L1-RSRP measurement for LTM however, it may be difficult for the network to make a proper mobility decision based on the quickly-varying measurement results. Filtering may be applied in the network or UE side for an event-triggered report (such as the L1 report) to increase the stability. The rough beam (or wide beam) may act as a filter as, compared with a fine beam (or narrow beam), a rough beam is a kind of filtering of fine beams since the rough beam width is larger than the fine beam width. An SSB is usually transmitted via rough beam, while data (e.g., a Physical Downlink Shared Channel (PDSCH)) may be transmitted using a fine beam. Note that a beam switch is not the same as a cell switch: additional tasks are involved for each handover (at least a partial MAC CE reset is expected, which may cause interruption). Therefore, a rough beam is used for the L1-RSRP measurement.

Thus, the intermediate L3 measurement may be used for the L1 report in LTM with multiple benefits. That is, rather than taking a new, fine beam measurement of the target cell, a L1 measurement previously obtained for a L3 measurement may be used (the L1 measurement and L3 measurement may have a different format). The L1 measurement may be a wide beam measurement rather than searching for the fine beam and obtaining a new L1 measurement using the fine beam. Such benefits include a reduction in UE implementation complexity without updating the current Rel-17 ICBM framework, a reduction in the L1 measurement delay for fine beam acquisition of a candidate cell, little to no impact to the L1 or L3 measurement delay of the serving cell, a solution to the timing offset issue of the Rel-17 ICBM framework, and a solution to the inter-frequency L1 measurement issue (i.e., avoiding the introduction of a new MG, or the sharing with L3 in a legacy MG, which reduces interruption and delay).

Another issue is to be resolved if intermediate L3 measurement may be used for the L1 report. If the L1-RSRP report is configured for beam management, the UE may fill in fine beam-based results. If the L1-RSRP report is configured for LTM however, the UE fills in the intermediate L3 results. Thus, the UE is to differentiate whether the L1 RSRP report configuration is for beam management or LTM to determine what operations to perform. For example, in the report configuration for LTM, a new field may be added to inform the UE of the L1-RSRP measurement type.

In current L3 measurement procedures, 5 samples are used for averaging for both the time domain and the beam domain. For LTM, this result is not filtered across the beam domain. For the time domain, a single shot or 3 sample filtered result may be used for the L1 report, and thus the measurement time is different from a legacy L3 measurement. The measurement period will be reduced as shown in Table 1:

TABLE 1

| DRX cycle | T _{SSB}_measurement_period_intra |
|---|---|
| No DRX | max(400 ms, ceil(Mₘₑₐₛ_period_w/o_gaps x Kₚ x |
| | K_{layer1}_measurement) x SMTC period)^{Note 1} x CSSFᵢₙₜᵣₐ |
| DRX | max(400 ms, ceil(1.5x Mₘₑₐₛ_period_w/o_gaps x Kₚ x |
| cycles ≤ | K_{layer1}_measurement) x max(SMTC period, DRX |
| 320 ms | cycle)) x CSSFᵢₙₜᵣₐ |
| DRX | ceil(Mₘₑₐₛ_period_w/o_gaps x Kₚ x K_{layer1}_measurement) x |
| cycle > | DRX cycle x CSSFᵢₙₜᵣₐ |
| 320 ms | |

NOTE 1:
If different SMTC periodicities are configured for different cells, the SMTC period in the requirement is the one used by the cell being identified

In legacy procedures, for a UE supporting the frequency range 2 (FR2)-2 power class 1, M_{meas_period_w/o_gaps CCA}=60, where 60=5*12, 5 is averaging over 5 samples, and the Rx beam sweeping factor 12. Due to the number of measurement samples being reduced, only 12 or 24 samples may be used.

Thus, the wide beam L3 measurement for the target cell (which is known to the UE) may be performed before the fine beam L1 measurement is triggered by the gNB. The selection of the rough beam also may reduce the time for the later fine beam measurement (as shown in FIG. 5) as the number of fine beams to be selected among for the UE is limited to the already-selected rough beam (rather than refining among the fine beams in multiple rough beams). This reduces the timing as, rather than searching through 64 or 128 fine beam directions for BM, only 4 or so fine beams in one of the 16, 32, or 64 rough beams are used for the BM. The measurements may be used in FR1 or FR2-1 for LTM, with the L3 measurement report containing L1-RSRP measurements on an SSB.

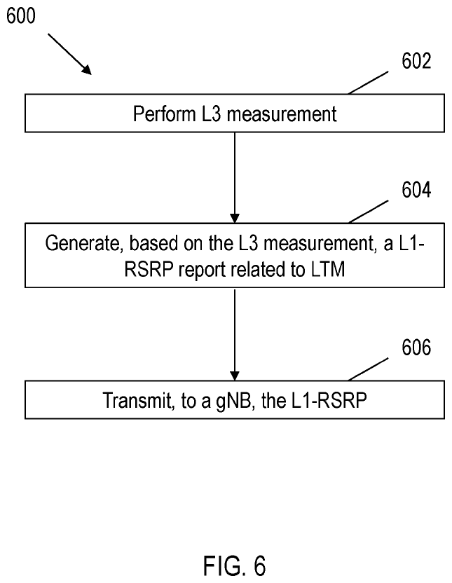

FIG. 6 illustrates a method of reporting L1-RSRP in accordance with some aspects. In some embodiments, the electronic device(s), network(s), system(s), chip(s) or component(s), or portions or implementations thereof of the figures herein may be configured to perform one or more processes, techniques, or methods as described herein, or portions thereof. One such process is depicted in FIG. 6, which may be implemented using a UE or portion thereof in some embodiments. For example, the process 600 may include performing a L3 measurement at operation 602. The process 600 may also include generating, based on the L3 measurement, a L1-RSRP report related to LTM at operation 604. The process 600 may also include transmitting the L1-RSRP report to a base station (e.g., gNB) at operation 606.

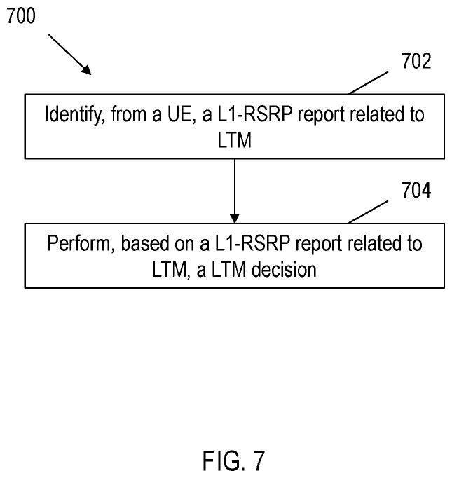

Another such process is depicted in FIG. 7, which illustrates a LTM decision making process in accordance with some aspects. The process 700 of FIG. 7 may include or relate to a method to be performed by a base station, one or more elements of a base station, and/or one or more electronic devices that include and/or implement a base station. The process 700 may include identifying, from a UE, a L1-RSRP report related to LTM at operation 702. The L1-RSRP report is based on a L3 measurement performed by the UE. At operation 704, the base station performs a LTM decision based on the L1-RSRP report.

### EXAMPLES

### Incorrect Numbering: 1

Example 1 is an apparatus configured to operate as a user equipment (UE), the apparatus comprising: processing circuitry to configure the UE to: receive a Radio Resource Control (RRC) reconfiguration message from a 5th generation NodeB (gNB), the RRC reconfiguration message containing a configuration for a Layer 1/Layer 2 (L1/L2) triggered mobility (LTM) target cell; receive, from the gNB, a trigger to measure L1-Reference Signal Received Power (L1-RSRP) of the LTM target cell; and transmit, to the gNB in response to the trigger, a previous L1-RSRP of the LTM target cell, the previous L1-RSRP previously used in a Layer 3 (L3) measurement; and a memory configured to store the previous L1-RSRP.

In Example 2, the subject matter of Example 1 includes, wherein the processing circuitry configures the UE to: receive, from the gNB after the RRC reconfiguration message, a Medium Access Control (MAC) Control Element (MAC CE) containing a cell switch command to switch to the LTM target cell; and perform, after reception of the MAC CE, another L1-RSRP measurement on the LTM target cell for inter-cell beam management (BM).

In Example 3, the subject matter of Example 2 includes, wherein the processing circuitry configures the UE to obtain fine beam acquisition of the LTM target cell based on the other L1-RSRP measurement.

In Example 4, the subject matter of Examples 1-3 includes, wherein the previous L1-RSRP measurement obtained using a rough beam.

In Example 5, the subject matter of Examples 1~4 includes, wherein the processing circuitry configures the UE to perform the previous L1-RSRP measurement inside a Synchronization Signal/Physical Broadcast Channel (SS/PBCH) Block Measurement Timing Configuration (SMTC).

In Example 6, the subject matter of Examples 1-5 includes, wherein the L3 measurement includes a L1-RSRP measurement that is not filtered across a beam domain.

In Example 7, the subject matter of Examples 1-6 includes, wherein the processing circuitry configures the UE to, in response to reception of the MAC CE, perform downlink (DL) synchronization and timing advance (TA) acquisition with the LTM target cell.

In Example 8, the subject matter of Examples 1-7 includes, wherein the processing circuitry configures the UE to, in response to reception of the MAC CE, engage in a Random Access Channel (RACH) procedure with the LTM target cell.

In Example 9, the subject matter of Examples 1-8 includes, wherein the L1-RSRP measurement includes a field that indicates a type of the L1-RSRP measurement, the type of the L1-RSRP measurement selected from among a L1-RSRP measurement for LTM and a L1-RSRP measurement for inter-cell beam management (BM).

In Example 10, the subject matter of Examples 1-9 includes, wherein the processing circuitry configures the UE to use one or 3 samples for the L1-RSRP measurement during a measurement time M_{meas_period_w/o_gaps CCA} of 12 or 24 samples.

Example 11 is an apparatus configured to operate as a 5th generation NodeB (gNB), the apparatus comprising: processing circuitry to configure the gNB to: receive, from a user equipment (UE), a Layer 3 (L3) measurement report for a Layer 1/Layer 2 (L1/L2) triggered mobility (LTM) target cell, the L3 measurement report based on a L1-Reference Signal Received Power (L1-RSRP) measurement of the LTM target cell; transmit, to the UE after reception of the L3 measurement report, a trigger for another L1-RSRP measurement of the LTM target cell; receive, from the UE after transmission of the trigger, the L1-RSRP measurement in a different format than the L3 measurement report; and transmit, to the UE after reception of the L1-RSRP measurement, a Medium Access Control (MAC) Control Element (MAC CE) containing a cell switch command to switch to the LTM target cell; and a memory configured to store the configuration.

In Example 12, the subject matter of Example 11 includes, wherein: the L1-RSRP measurement is based on data obtained by a rough beam, and the processing circuitry configures the gNB to receive, from the UE after transmission of the MAC CE, another L1-RSRP measurement on the LTM target cell based on data obtained by a fine beam.

In Example 13, the subject matter of Example 12 includes, wherein: the L1-RSRP measurement is performed inside a Synchronization Signal/Physical Broadcast Channel (SS/PBCH) Block Measurement Timing Configuration (SMTC), and the other L1-RSRP measurement is performed for inter-cell beam management (BM).

In Example 14, the subject matter of Examples 11-13 includes, wherein the L3 measurement report includes a field that indicates a type of the L1-RSRP measurement, the type of the L1-RSRP measurement selected from among a L1-RSRP measurement for LTM and a L1-RSRP measurement for inter-cell beam management (BM).

Example 15 is a computer-readable storage medium that stores instructions for execution by one or more processors of a user equipment (UE), the one or more processors to configure the UE to, when the instructions are executed: receive a Radio Resource Control (RRC) reconfiguration message from a 5th generation NodeB (gNB), the RRC reconfiguration message containing a configuration for a Layer 1/Layer 2 (L1/L2) triggered mobility (LTM) target cell; receive, from the gNB, a trigger to measure L1-Reference Signal Received Power (L1-RSRP) of the LTM target cell; and transmit, to the gNB in response to the trigger, a previous L1-RSRP of the LTM target cell, the previous L1-RSRP previously used in a Layer 3 (L3) measurement.

In Example 16, the subject matter of Example 15 includes, wherein the one or more processors configure the UE to, when the instructions are executed: receive, from the gNB after the RRC reconfiguration message, a Medium Access Control (MAC) Control Element (MAC CE) containing a cell switch command to switch to the LTM target cell; and perform, after reception of the MAC CE, another L1-RSRP measurement on the LTM target cell for inter-cell beam management (BM).

In Example 17, the subject matter of Example 16 includes, wherein the one or more processors configure the UE to, when the instructions are executed, perform the previous L1-RSRP measurement inside a Synchronization Signal/Physical Broadcast Channel (SS/PBCH) Block Measurement Timing Configuration (SMTC).

In Example 18, the subject matter of Examples 15-17 includes, wherein the one or more processors configure the UE to, when the instructions are executed, in response to reception of the MAC CE, perform downlink (DL) synchronization and timing advance (TA) acquisition with the LTM target cell.

In Example 19, the subject matter of Examples 15-18 includes, wherein the L1-RSRP measurement includes a field that indicates a type of the L1-RSRP measurement, the type of the L1-RSRP measurement selected from among a L1-RSRP measurement for LTM and a L1-RSRP measurement for inter-cell beam management (BM).

In Example 20, the subject matter of Examples 15-19 includes, wherein the one or more processors configure the UE to, when the instructions are executed, use one or 3 samples for the L1-RSRP measurement during a measurement time M_{meas_period_w/o_gaps CCA} of 8 or 24 samples.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

The invention claimed is:

1-20. (canceled)

21. An apparatus configured to operate as a user equipment (UE), the apparatus comprising:
processing circuitry to configure the UE to:
receive a Radio Resource Control (RRC) reconfiguration message from a 5^{th} generation NodeB (gNB), the RRC reconfiguration message containing a configuration for a Layer 1/Layer 2 (L1/L2) triggered mobility (LTM) target cell;
receive, from the gNB, a trigger to measure L1-Reference Signal Received Power (L1-RSRP) of the LTM target cell; and
transmit, to the gNB in response to the trigger, a previous L1-RSRP measurement of the LTM target cell, the previous L1-RSRP measurement previously used in a Layer 3 (L3) measurement; and
a memory configured to store the previous L1-RSRP measurement.

22. The apparatus of claim 21, wherein the processing circuitry configures the UE to:
receive, from the gNB after the RRC reconfiguration message, a Medium Access Control (MAC) Control Element (MAC CE) containing a cell switch command to switch to the LTM target cell; and
perform, after reception of the MAC CE, another L1-RSRP measurement on the LTM target cell for inter-cell beam management (BM).

23. The apparatus of claim 22, wherein the processing circuitry configures the UE to obtain fine beam acquisition of the LTM target cell based on the other L1-RSRP measurement.

24. The apparatus of claim 21, wherein the previous L1-RSRP measurement obtained using a rough beam.

25. The apparatus of claim 21, wherein the processing circuitry configures the UE to perform the previous L1-RSRP measurement inside a Synchronization Signal/Physical Broadcast Channel (SS/PBCH) Block Measurement Timing Configuration (SMTC).

26. The apparatus of claim 21, wherein the L3 measurement includes a L1-RSRP measurement that is not filtered across a beam domain.

27. The apparatus of claim 21, wherein the processing circuitry configures the UE to, in response to reception of a Medium Access Control (MAC) Control Element (MAC CE) containing a cell switch command to switch to the LTM target cell, perform downlink (DL) synchronization and timing advance (TA) acquisition with the LTM target cell.

28. The apparatus of claim 21, wherein the processing circuitry configures the UE to, in response to reception of a Medium Access Control (MAC) Control Element (MAC CE) containing a cell switch command to switch to the LTM target cell, engage in a Random Access Channel (RACH) procedure with the LTM target cell.

29. The apparatus of claim 21, wherein the previous L1-RSRP measurement includes a field that indicates a type of the previous L1-RSRP measurement, the type of the previous L1-RSRP measurement selected from among a L1-RSRP measurement for LTM and a L1-RSRP measurement for inter-cell beam management (BM).

30. The apparatus of claim 21, wherein the processing circuitry configures the UE to use one or 3 samples for the previous L1-RSRP measurement during a measurement time M_{meas_period_w/o_gaps CCA} of 12 or 24 samples.

31. An apparatus configured to operate as a 5^{th} generation NodeB (gNB), the apparatus comprising:
processing circuitry to configure the gNB to:
receive, from a user equipment (UE), a Layer 3 (L3) measurement report for a Layer 1/Layer 2 (L1/L2) triggered mobility (LTM) target cell, the L3 measurement report based on a L1-Reference Signal Received Power (L1-RSRP) measurement of the LTM target cell;
transmit, to the UE after reception of the L3 measurement report, a trigger for another L1-RSRP measurement of the LTM target cell;
receive, from the UE after transmission of the trigger, the L1-RSRP measurement in a different format than the L3 measurement report; and
transmit, to the UE after reception of the L1-RSRP measurement, a Medium Access Control (MAC) Control Element (MAC CE) containing a cell switch command to switch to the LTM target cell; and
a memory configured to store the L1-RSRP measurement.

32. The apparatus of claim 31, wherein:
the L1-RSRP measurement is based on data obtained by a rough beam, and
the processing circuitry configures the gNB to receive, from the UE after transmission of the MAC CE, another L1-RSRP measurement on the LTM target cell based on data obtained by a fine beam.

33. The apparatus of claim 32, wherein:
the L1-RSRP measurement is performed inside a Synchronization Signal/Physical Broadcast Channel (SS/PBCH) Block Measurement Timing Configuration (SMTC), and
the other L1-RSRP measurement is performed for inter-cell beam management (BM).

34. The apparatus of claim 31, wherein the L3 measurement report includes a field that indicates a type of the L1-RSRP measurement, the type of the L1-RSRP measurement selected from among a L1-RSRP measurement for LTM and a L1-RSRP measurement for inter-cell beam management (BM).

35. A computer-readable storage medium that stores instructions for execution by one or more processors of a user equipment (UE), the one or more processors to configure the UE to, when the instructions are executed:
receive a Radio Resource Control (RRC) reconfiguration message from a 5^{th} generation NodeB (gNB), the RRC reconfiguration message containing a configuration for a Layer 1/Layer 2 (L1/L2) triggered mobility (LTM) target cell;
receive, from the gNB, a trigger to measure L1-Reference Signal Received Power (L1-RSRP) of the LTM target cell; and
transmit, to the gNB in response to the trigger, a previous L1-RSRP measurement of the LTM target cell, the previous L1-RSRP measurement previously used in a Layer 3 (L3) measurement.

36. The computer-readable storage medium of claim 35, wherein the one or more processors configure the UE to, when the instructions are executed:
receive, from the gNB after the RRC reconfiguration message, a Medium Access Control (MAC) Control Element (MAC CE) containing a cell switch command to switch to the LTM target cell; and
perform, after reception of the MAC CE, another L1-RSRP measurement on the LTM target cell for inter-cell beam management (BM).

37. The computer-readable storage medium of claim 36, wherein the one or more processors configure the UE to, when the instructions are executed, perform the previous L1-RSRP measurement inside a Synchronization Signal/Physical Broadcast Channel (SS/PBCH) Block Measurement Timing Configuration (SMTC).

38. The computer-readable storage medium of claim 35, wherein the one or more processors configure the UE to, when the instructions are executed, in response to reception of a Medium Access Control (MAC) Control Element (MAC CE) containing a cell switch command to switch to the LTM target cell, perform downlink (DL) synchronization and timing advance (TA) acquisition with the LTM target cell.

39. The computer-readable storage medium of claim 35, wherein the previous L1-RSRP measurement includes a field that indicates a type of the previous L1-RSRP measurement, the type of the previous L1-RSRP measurement selected from among a L1-RSRP measurement for LTM and a L1-RSRP measurement for inter-cell beam management (BM).

40. The computer-readable storage medium of claim 35, wherein the one or more processors configure the UE to, when the instructions are executed, use one or 3 samples for the previous L1-RSRP measurement during a measurement time M_{meas_period_w/o_gaps CCA} of 8 or 24 samples.
